(19) United States
(12) Patent Application Publication
(10) Pub. No.: US 2003/0046785 A1
(43) Pub. Date: Mar. 13, 2003

(54) Cleaning mat and manufacturing method for the same

(75) Inventors: Yoshiharu Shiroki, Tokyo (JP); Hiroshi Koda, Saitama-shi (JP)

Correspondence Address: ARMSTRONG,WESTERMAN & HATTORI, LLP, 1725 K STREET, NW, SUITE 1000, WASHINGTON, DC, 20006, US

(73) Assignee: MEIWA RUBBER CO., LTD., Tokyo (JP)

(21) Appl. No.: 09/947,388

(22) Filed: Sep. 7, 2001

(51) Int. Cl. B08B 1/04

(52) U.S. Cl. 15/256.52; 101/425

(57) ABSTRACT

A cleaning mat provided with a single rubber layer including many extra-fine short fibers. The extra-fine short fibers are undirectionally protruding from a surface of the rubber layer to form brush-like protruding portions. The cleaning mat is made by polishing the surface of the rubber layer composed of a mixture of raw rubber material and the extra-fine short fibers.

### BACKGROUND OF THE INVENTION

1. Field of the Invention

This invention relates to a cleaning mat and a manufacturing method for the same.

2. Description of the Related Art

Conventionally, for cleaning an Anilox Roll (a roll to be cleaned) used for a flexo coater (painter) attached to a flexo printing machine and an offset printing machine after printing, the roll to be cleaned is sprinkled with detergent and cleaned on the machine by manual work with clothe or brush, or the roll is detached from the printing machine and cleaned by manual work or a special cleaning apparatus.

However, the cleaning by manual work on or off the machine causes much labor on the worker and increases number of processes. That is to say, in case of cleaning on the machine, much labor is required for wiping the cleaned roll rotating and sprinkled with detergent with clothes or brushes, the detergent may drop on the worker, and the worker may inhale volatile matter when organic solvent is used. These things cause safety problems. On the other hand, also in cleaning off the machine, labor and extra number of processes are loaded on the worker as in the case of the cleaning on the machine, and this is desired to be improved for solving problems in sanitary control.

And, when the special cleaning apparatus is used, high cost is caused for newly-required apparatus and equipment.

Further, when frequency of the printing and painting work is high like recent years, the cleaning on the machine is desired to be conducted as much as swiftly and effectively for prevention of low working ratio of the printing machine or the painter.

It is therefore an object of the present invention to provide a cleaning mat and a manufacturing method for the same with which the roll can be cleaned on the machine for a long period with stability, efficiency, and uniformity without expensive special cleaning apparatus and human hands.

### BRIEF DESCRIPTION OF THE DRAWINGS

The present invention will be described with reference to the accompanying drawings in which:

FIG. 1 is an enlarged cross-sectional view showing an embodiment of the present invention;

FIG. 2 is a partial top view;

FIG. 3 is an enlarged cross-sectional view of a principal portion when thicknesses of extra-fine short fibers are the same;

FIG. 4 is an enlarged cross-sectional view of a principal portion when thicknesses of extra-fine short fibers vary;

FIG. 5 is an explanatory view of a flexo coater set on an offset printing machine;

FIG. 6 is an enlarged cross-sectional view showing a state in which crank bars are attached;

FIG. 7 is an explanatory view of usage in a flexo coater;

FIG. 8A is a working explanatory view of a principal portion;

FIG. 8B is a working explanatory view of the principal portion;

FIG. 8C is a working explanatory view of the principal portion;

FIG. 9A is a working explanatory view of a principal portion of a comparison example;

FIG. 9B is a working explanatory view of the principal portion of the comparison example;

FIG. 9C is a working explanatory view of the principal portion of the comparison example;

FIG. 10 is a n explanatory view of manufacturing method;

FIG. 11 is an enlarged cross-sectional view showing another embodiment of the present invention;

FIG. 12 is an enlarged cross-sectional view showing still another embodiment of the present invention; and

FIG. 13 is an enlarged cross-sectional view showing a further embodiment of the present invention.

### DESCRIPTION OF THE PREFERRED EMBODIMENTS

Preferred embodiments of the present invention will now be described with reference to the accompanying drawings.

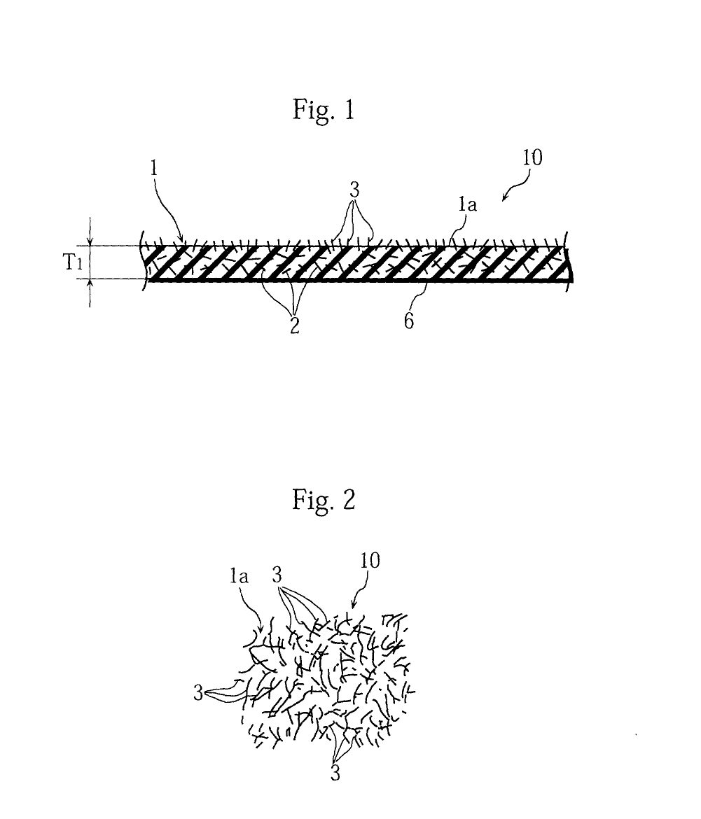

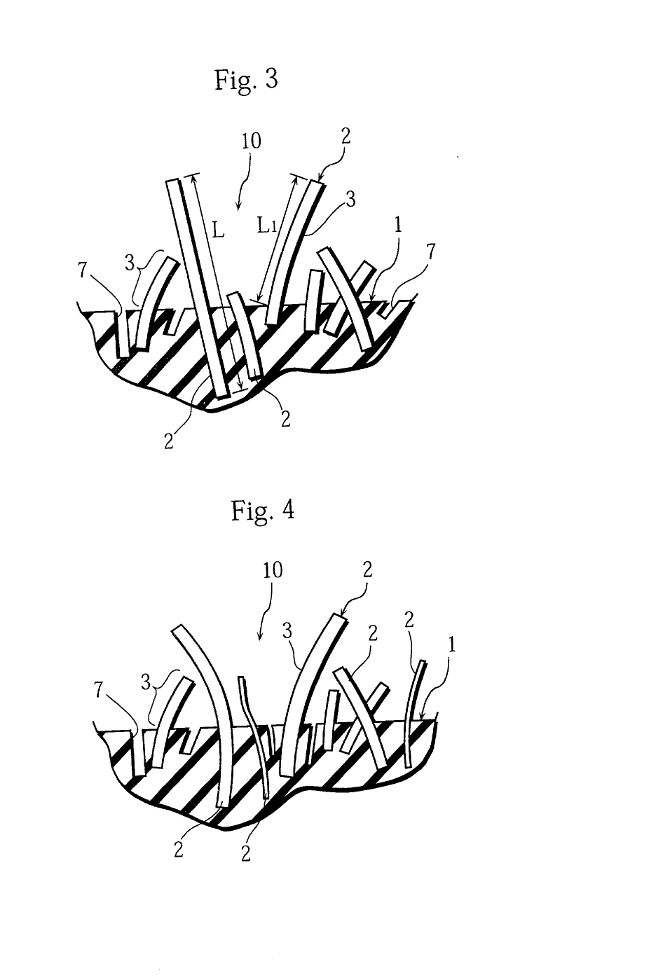

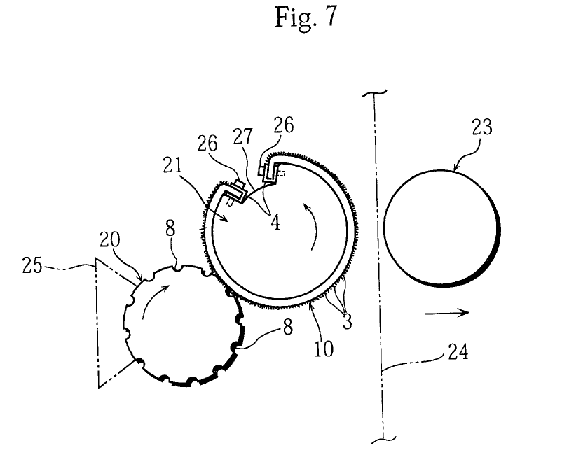

FIG. 1 through FIG. 3 show an embodiment of the cleaning mat relating to the present invention. FIG. 1 is a cross-sectional view, FIG. 2 is a partial top view, and FIG. 3 is an enlarged cross-sectional view of a principal portion. In these FIG. 1 through FIG. 3, a cleaning mat 10 is provided with a single rubber layer 1 including numerous extra-fine short fibers 2. The extra-fine short fibers 2, protruding from a surface 1a of the rubber layer 1 undirectionally, compose brush-like protruding portions 3. The cleaning mat 10 is, as shown in FIG. 7, rolled onto an attachment roll 21 of a printing machine and used for cleaning (cell portions 8 and a peripheral face) of a cleaned roll 20 facing the attachment roll 21.

To describe concretely, the brush-like protruding portions 3 are formed by protruding the extra-fine short fibers 2 from the surface 1a as brush hairs with abrasion of the surface 1a of the rubber layer 1. In this case, micro holes 7 from which the extra-fine short fibers 2 are pulled out by the abrasion are formed on the rubber layer 1.

Each of length dimensions (protruding length from the surface 1a of the rubber layer 1) of the brush-like protruding portions 3 is different from one another, and the brush-like protruding portions 3 are protruding undirectionally (at random). “Undirectional” means that directionality of inclination of the brush-like protruding portions 3 does not exist in top view.

Average length dimension of the brush-like protruding portions 3 is set to be 0.1 mm to 3.0 mm to clean the cleaned roll 20 efficiently. The average length dimension is defined as an average value of length dimensions of all of the brush-like protruding portions 3.

That is to say, when the average length dimension is less than 0.1 mm, cleaning effect is decreased because forth ends of the brush-like protruding portions 3 can not reach for bottoms of the large cell portions (concave portions) 8 of the cleaned roll 20 in cleaning. On the other hand, when the average length dimension is more than 3 mm, cleaning effect is also lowered because rigidity of the brush-like protruding portions 3 is decreased. In this case, the maximum length dimension L₁ of the brush-like protruding portions 3 is 0.2 mm to 4 mm.

Further, the extra-fine short fibers 2 forming the brush-like protruding portions 3, preferably made of fibers having high solvent resistance and strength, are composed of extra-fine chemical fibers (such as nylon, polyesther, etc.) or extra-fine metal fibers (such as nickel, steel, brass, copper, etc.) The brush-like protruding portions 3 are set to have appropriate length by arranging a length dimension L of the extra-fine short fibers 2 to be 0.5 mm to 5 mm. That is to say, when the length dimension L is less than 0.5 mm, the length of the brush-like protruding portions 3 is insufficient, and when the length dimension L is more than 5 mm, the brush-like protruding portions 3 become too long.

The cleaned roll 20 can be efficiently cleaned by setting thickness of the extra-fine short fiber 2 to be 2 to 20 deniers. That is to say, when the thickness is less than 2 deniers, cutting occurs in the fiber and rigidity is insufficient. When the thickness is more than 20 deniers, rigidity of the fiber becomes excessive to clean fine parts on the cleaned roll 20 and the fiber is easily broken.

And, as shown in FIG. 4, it is also preferable to correspond to various dimensions and configurations of the cell portions 8 of the cleaned roll 20 with the rubber layer 1 including (at the same time) extra-fine short fibers 2 of at least two kinds of different thicknesses.

The hardness of the rubber layer 1 is set to be 30 to 48 degrees in JIS-A (Shore A) to improve flexibility of the rubber layer 1, the rubber layer 1 contacts with larger areas and bites into the cell portions 8 of the cleaned roll 20, and cleaning effect is improved further. That is to say, when the hardness is less than 30, the rubber layer 1 can not bear the abrasion with the cleaned roll 20 for excessive softness, and when the hardness is more than 48, the rubber layer does not bite into the cell portions 8 of the cleaned roll 20 for the excessive hardness, and the cleaning effect is reduced thereby.

And, the cleaning mat 10 formed thin only with the single rubber layer 1 can be applied to a flexo coater set on an offset printing machine (of which aperture between the cleaned roll 20 and the attachment roll 21 is narrow) with a thickness T₁ of the rubber layer set to be 1 to 3 mm.

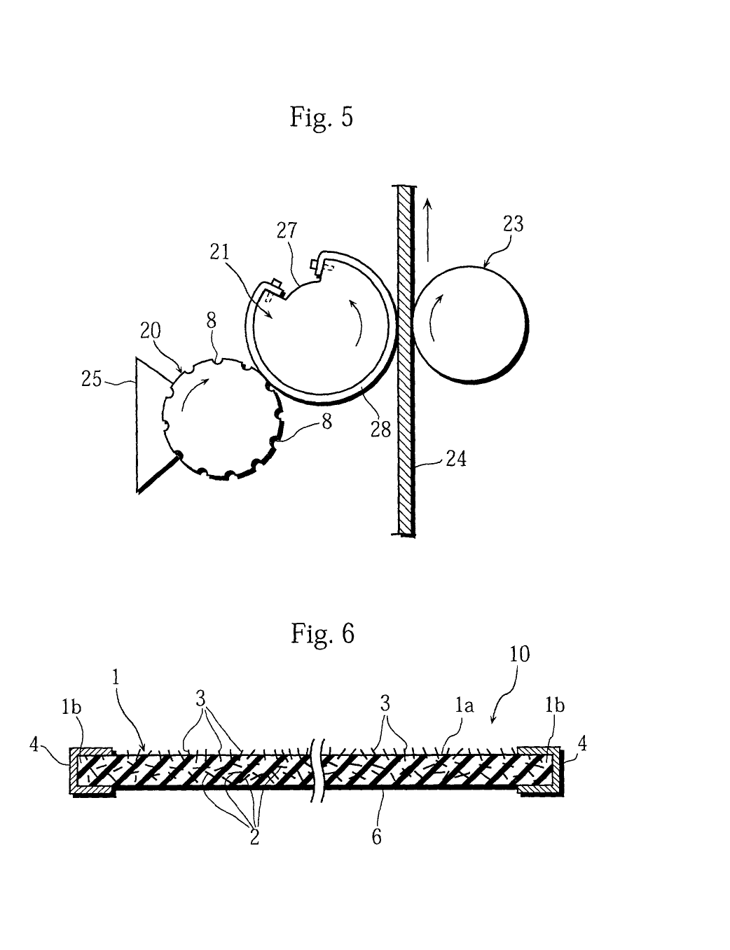

In the flexo coater set on the offset printing machine, as shown in FIG. 5, ink (varnish) is transferred from a ink chamber 25 to a blanket cylinder 28 outserted to the blanket roll (the attachment roll 21) through an Anilox roll (the cleaned roll 20), transferred from the blanket cylinder 28 to a printed matter 24 (such as a paper and a plastic sheet). The impression cylinder 23, disposed as to face the blanket cylinder 28, presses the printed matter 24 to the blanket cylinder 28 to ensure the print of the printed matter 24.

And, to apply the cleaning mat 10 to the flexo coater, firstly, as shown in FIG. 6, each of crank bars 4 to mechanically fix the rubber layer 1 after winding onto the attachment roll 21 is attached to both end portions 1b of the rubber layer 1. The crank bar 4 made of aluminum is a bar (of regular size) of which cross-section is U-shaped, and the end portion 1b of the rubber layer 1 is inserted to an inner portion (concave portion) of the crank bar 4 and pressurized to be fixed.

Then, as shown in FIG. 7, the impression cylinder 23 is parted from the attachment roll 21 to detach the blanket cylinder 28 (refer to FIG. 5) from the attachment roll 21, the cleaning mat 10 is wound around the attachment roll 21 with the crank bar 4 sides (detachably) attached to attachment concave portions 27 of the attachment roll 21 through fixation pieces 26 (such as bolts). In this case, the attachment of the cleaning mat 10 to the attachment roll 21 can be conducted certainly, swiftly, and easily with the crank bars 4.

That is to say, in case that the cleaning mat 10 is attached to the attachment roll 21 with double-sided adhesive tape or adhesive material, the cleaning mat 10 may be ripped off in cleaning work and in time transition, attachment process and time are required, and the cleaning mat 10 having an adhesive layer becomes thick (thickness is more than 3 mm) to be attached between the cleaned roll 20 and the attachment roll 21.

And, contact rotation cleaning is conducted by the cleaning mat 10, which contacts the cleaned roll 20 and rotates, with low-volatility detergent is poured between the cleaning mat 10 and the cleaned roll 20 or into the ink chamber 25.

To describe concretely, ink (paint) remains in the cell portion 8 of the cleaned roll 20 before cleaning, the brush-like protruding portions 3 sufficiently bite into the cell portion 8 and contact all areas in the cell portion 8 to certainly remove the ink in the cell portion 8 with the synergistic effect of the flexibility of the cleaning mat 10 and the undirectionality of the brush-like protruding portions 3.

And, the cleaning mat 10 is prevented from peeling caused by deformation by contact pressure with the cleaned roll 20 in cleaning work by giving flexibility to the cleaning mat 10. Especially, also in case that the contact pressure is raised to improve the cleaning effect, the peeling of the cleaning mat 10 is prevented.

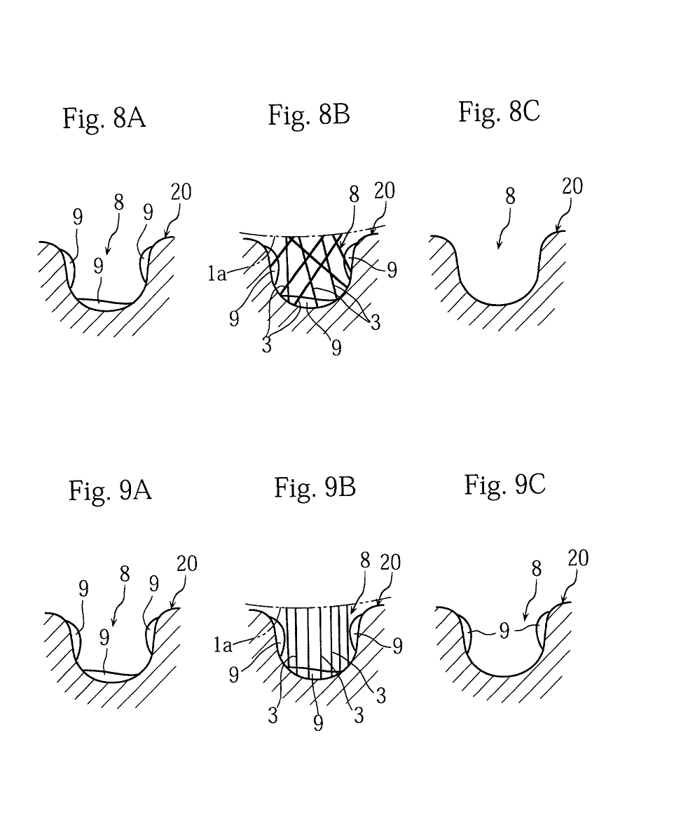

Work of the undirectionality of the protruding directions of the brush-like protruding portions 3 is described further in detail. As shown in FIG. 8A, although ink 9 remains on the bottom face and side faces in the cell portion 8 of the cleaned roll 20 before cleaning, the brush-like protruding portions 3, undirectionally protruding as shown in FIG. 8B, can contact the bottom face and side faces in the cell portion 8, and the ink 9 is certainly removed as shown in FIG. 8C. As a comparison example, in case that the brush-like protruding portions 3 are protruding in the same direction, ink 9 remains in the cell portion 8 of the cleaned roll 20 before cleaning as shown in FIG. 9A, the brush-like protruding portions 3 hardly contact the side faces of the cell portion 8 as shown in FIG. 9B, and the ink 9 on the side faces of the cell portion 8 can not be removed as shown in FIG. 9C. And, although not shown in figures, in case that the cross-sectional configuration of the cell portion 8 is trapezoid or rectangle, although ink in corner portions of the cell portion 8 can not be removed when the protruding directions are in “the same direction”, the ink is certainly removed when the protruding directions are “undirectional”. Even if the cross section of the cell portion 8 is formed in other various configurations, similar effect is obtained.

The cleaning mat 10 can be used for a printing machines other than the above-described offset printing machine by setting the thickness T₁ of the rubber layer 1 to be various dimensions. For example, the thickness T₁ is about 7 mm for a flexo printing machine for cardboards, and the thickness T₁ is about 3 mm for a flexo printing machine of general use.

And, for the attachment of the cleaning mat 10 to the attachment roll 21, double-sided tape or adhesive may be used (when the thickness T₁ of the rubber layer 1 does not raise a problem). In this case, it is preferable to form an attachment reverse face 6 (refer to FIG. 1), which contacts the attachment roll 21 of the cleaning mat 10, coarse to decrease surface tension, increase affinity with double-sided tape or adhesive for easy improvement of adhesion strength with the attachment roll 21, and prevent peeling.

To describe concretely, the attachment reverse face 6 is made coarse in a chemical method or a physical method. Firstly, in the chemical method, for example, after a blended liquid of trichloro cyanuric acid and ethyl acetate is painted on the attachment reverse face 6, the attachment reverse face 6 is made coarse by active chlorine generated by promoting decomposition of trichloro cyanuric acid with vaporization heat of ethyl acetate. As another method, acrylic or chloroprenic adhesive is solved by an organic solvent such as toluene and painted on the attachment reverse face 6 to degrease and make sticky. Secondly, the physical method is conducted by corona treatment, sand blast treatment, or ultraviolet ray (with UVC light source) treatment. Or, as a mold used for press working in production of the cleaning mat 10 (described later), a conventionally used silicon mold is replaced with a fluorine baking mold having low transition, and the attachment reverse face 6 is made concavo-convex in production process of the cleaning mat 10.

In the composition of the cleaning mat 10, main component NBR having a low ratio of acrylonitrile is adopted to improve flexibility, and amount of softening agent such as DOP is increased to reduce hardness and raise reactional elasticity for improvement of the cleaning effect. For example, the cleaning mat 10 is composed of totally 590 units of components, namely 50 units of NBR (including 33% of combined acrylonitrile), 50 units of NBR/PVC (70/30), 5 units of zinc oxide, 30 units of hard clay, 2 units of antioxidant, 5 units of gelatine, 40 units of DOP, 5 units of cumarone oil, 1.5 units of promotion CZ, 1.5 units of sulphur, and 400 units of short fiber (extra-fine short fiber). Naturally, other compositions are possible.

Next, the manufacturing method of the present invention is described. Firstly, NBR (raw rubber material), main component of the above-mentioned composition, is kneaded beforehand, and short fibers (the extra-fine short fibers 2) are sufficiently dried to improve dispersion in mixture.

And, the dried many extra-fine short fibers 2 and other components are mixed with the pre-kneaded main component, namely the raw rubber material, kneaded to make a composite rubber using a mixer (such as a kneader, a banbury mixer, etc.), and matured for approximately seven days.

Then, the composite rubber is heated again with the mixer, kneaded again by an open roll, and pressed out as a sheet having predetermined thickness and size by a calender roller.

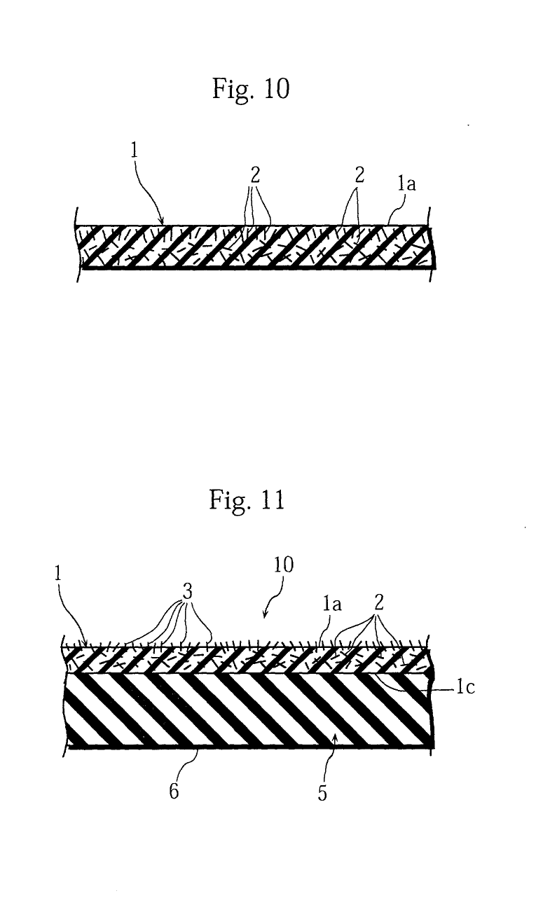

And, the sheet of the composite rubber is pressurized with a pressure of 25 to 30 kg/cm² and under 140° C., vulcanized with 30-minute press to form the single rubber layer 1 as shown in FIG. 10. In the press, smoothness is given to the sheet of the composite rubber by a mold (a forming plate) on which the sheet is set.

After the press, the surface la of the press-worked rubber layer 1 is polished by a polishing machine to regulate the thickness as to be a predetermined thickness (as shown in FIG. 1), and the extra-fine short fibers 2 are made undirectionally protruding from the surface 1a to form the (well-fuzzed) brush-like protruding portions 3.

Next, FIG. 11 shows another embodiment of the present invention. This cleaning mat 10 is composed of the (above-described) rubber layer 1 and an elastic layer 5 layered on a reverse face 1c of the rubber layer 1. The elastic layer 5 is composed of rubber or plastic which is organic-solvent-resistant, acid-resistant, alkali-resistant, or chemical-resistant, for example, nitrile butylene rubber (NBR), vinyl chloride resin (PVC), ethylene propylene rubber (EPT), etc. Other kinds of rubber or plastic may also be used. And, thickness dimension of the elastic layer 5 is freely set as to correspond to the dimension between the cleaned roll 20 and the attachment roll 21. And, hardness of the elastic layer 5 is set to be 20 to 50 degrees in JIS-A. Therefore, the elastic layer 5, having high elasticity and compression-resistant deformity, can press the rubber layer 1 layered on the elastic layer 5 further stably as to bite into the cleaned roll 20.

In the case of this cleaning mat 10, it is preferable to form the attachment reverse face 6 of the cleaning mat 10 (the elastic layer 5) coarse because the cleaning mat 10 is attached to the attachment roll 21 with an adhesive layer such as a double-sided tape or adhesive.

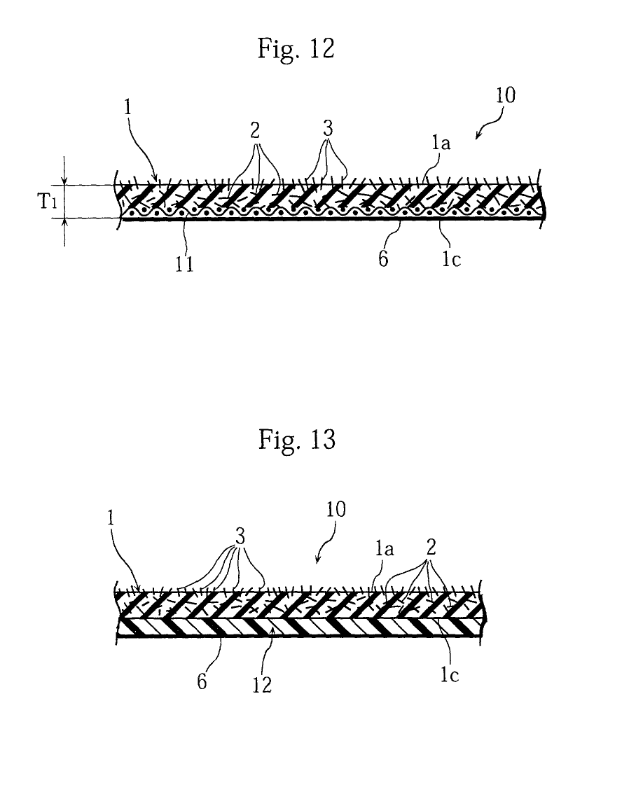

Next, FIG. 12 shows an enlarged cross-sectional view of still another embodiment of the present invention. This cleaning mat 10 is constructed as that an elongation prevention canvas (cloth) 11 is (unitedly) embedded in the reverse face 1c side of the (above-described) rubber layer 1. Elongation of the rubber layer 1 generated (by tension) when the cleaning mat 10 is wound around the attachment roll 21 can be regulated (reduced) by the canvas 11 with various degrees. To describe the manufacturing method of the cleaning mat 10, the elongation prevention canvas 11 is laid in a mold for vulcanization (not shown in Figures), composite rubber made by mixing and kneading many extra-fine short fibers 2 with raw rubber material is fed to the mold, the single rubber layer 1 in which the canvas 11 is embedded on the reverse face 1c side by heating with press and vulcanization, and, after the rubber layer 1 is taken out of the mold, brush-like protruding portions 3 are formed by making the extra-fine short fibers 2 protruding undirectionally from a surface 1a of the rubber layer 1 by means of polishing the surface 1a of the rubber layer 1.

Next, FIG. 13 shows an enlarged cross-sectional view of a further embodiment of the present invention. This cleaning mat 10 is composed of the (above-described) rubber layer 1 and an elongation prevention plastic sheet 12 layered on the reverse face 1c of the rubber layer 1. Elongation of the rubber layer 1 generated (by tension) when the cleaning mat 10 is wound around the attachment roll 21 can be regulated (reduced) by the plastic sheet 12 to various degrees.

In the present invention, not restricted to the above-described embodiments, the construction of the invention can be changed within the scope of the invention, for example, the cleaning mat 10 may be attached partially to the attachment roll 21. And, the cleaning mat 10 may be glued on a carrier sheet (a sheet of plastic or metal) which is stuck to (wound around) the attachment roll 21.

According to the cleaning mat of the present invention, the cleaned roll 20 can be easily cleaned by the cleaning mat 10 attached to the attachment roll 21. And, remaining ink in the cell portion 8 can be certainly removed because the brush-like protruding portions 3 sufficiently bite into the cell portion 8 of the cleaned roll 20 by means of elasticity of the rubber layer 1, and the brush-like protruding portions 3 are undirectionally protruding. Further, the cleaning mat 10 composed of a single rubber layer 1 can be thin and preferable for a flexo coater of a printing machine (such as an offset printing machine) in which a gap between the attachment roll 21 and the cleaned roll 20 is narrow. As described above, the cleaning mat is economical without expensive special cleaning apparatus. And, the cleaning does not cause safety and sanitary problems because the cleaning is conducted without human hands, extra labor and working process are not required, and workers do not touch the detergent and inhale the volatile organic solvent. Further, the roll can be tidily cleaned on the machine within a short period of time and with uniformity.

And, the cleaned roll 20 can be easily cleaned by the cleaning mat 10 attached to the attachment roll 21. And, remaining ink in the cell portion 8 can be certainly removed because the brush-like protruding portions 3 sufficiently bite into the cell portion 8 of the cleaned roll 20 by means of elasticity of the rubber layer 1, and the brush-like protruding portions 3 are undirectionally protruding. And, elongation generated (by tension) when the cleaning mat 10 is wound around the attachment roll 21 can be prevented by the canvas 11. Further, the cleaning mat 10 composed of a single rubber layer 1 can be thin and preferable for a flexo coater of a printing machine (such as an offset printing machine) in which a gap between the attachment roll 21 and the cleaned roll 20 is narrow. As described above, the cleaning mat is economical without expensive special cleaning apparatus. And, the cleaning does not cause safety and sanitary problems because the cleaning is conducted without human hands, extra labor and working process are not required, and workers do not touch the detergent and inhale the volatile organic solvent. Further, the roll can be tidily cleaned on the machine within a short period of time and with uniformity.

And, the cleaning mat 10 can be attached to the attachment roll 21 with the crank bar 4 certainly, swiftly, and easily. It is not necessary to use adhesive (such as double-sided tape or adhesive agent) because the cleaning mat is mechanically attached. Therefore, it is needless to consider peeling and working time generated by the use of adhesive. Further, the cleaning mat 10 can be made thin because adhesive (adhesive layer) is not used.

And, the cleaned roll 20 can be easily cleaned with the cleaning mat 10 attached to the attachment roll 21. And, remaining ink in the cell portion 8 can be certainly removed because the brush-like protruding portions 3 sufficiently bite into the cell portion 8 of the cleaned roll 20 by means of elasticity of the rubber layer 1 and the elastic layer 5, and the brush-like protruding portions 3 are undirectionally protruding. Further, the thickness of the cleaning mat 10 can be easily and economically changed by changing the thickness of the elastic layer 5. As described above, the cleaning mat is economical without expensive special cleaning apparatus. And, the cleaning does not cause safety and sanitary problems because the cleaning is conducted without human hands, extra labor and working process are not required, and workers do not touch the detergent and inhale the volatile organic solvent. Further, the roll can be tidily cleaned on the machine within a short period of time and with uniformity.

And, the cleaned roll 20 can be easily cleaned with the cleaning mat 10 attached to the attachment roll 21. And, remaining ink in the cell portion 8 can be certainly removed because the brush-like protruding portions 3 sufficiently bite into the cell portion 8 of the cleaned roll 20 by means of elasticity of the rubber layer 1, and the brush-like protruding portions 3 are undirectionally protruding. And, elongation generated (by tension) when the cleaning mat 10 is wound around the attachment roll 21 can be prevented by the plastic sheet 12. Further, the thickness of the cleaning mat 10 can be easily and economically changed by changing the thickness of the plastic sheet 12. As described above, the cleaning mat is economical without expensive special cleaning apparatus. And, the cleaning does not cause safety and sanitary problems because the cleaning is conducted without human hands, extra labor and working process are not required, and workers do not touch the detergent and inhale the volatile organic solvent. Further, the roll can be tidily cleaned on the machine within a short period of time and with uniformity.

And, surface tension is decreased and affinity with adhesive (such as double-sided tape and adhesive agent) to easily improve adhesion strength with the attachment roll 21 and prevent peeling because the attachment reverse face 6 which contacts the attachment roll 21 is formed coarse.

And, flexibility is given to the cleaning mat 10 to improve the affinity and fitness with the attachment roll 21 further because the hardness of the rubber layer 1 is set to be 30 to 48 degrees in JIS-A. And, cleaning effect is heightened further for increased contact and biting area on the cleaned roll 20.

Further, the cleaning mat 10 can correspond to various dimensions and configurations of the cell portion 8 of the cleaned roll 20 because the thickness of the extra-fine short fiber 2 is set to be 2 to 20 deniers and the rubber layer 1 includes at least two kinds of extra-fine short fibers 2 having different thicknesses.

And, the cleaned roll 20 can be efficiently cleaned because the average length of the brush-like protruding portions 3 is set to be 0.1 to 3 mm. Further, the cleaning mat 10 can be also applied to a cleaned roll 20 of which cell portion 8 is deep.

According to the manufacturing method of cleaning mat of the present invention, the cleaning mat 10, composed of the single rubber layer 1 having the brush-like protruding portions 3, can be easily made.

And, the cleaning mat 10, composed of the single rubber layer 1 in which the canvas 11 is embedded and the brush-like protruding portions 3 are formed, can be easily made.

While preferred embodiments of the present invention have been described in this specification, it is to be understood that the invention is illustrative and not restrictive, because various changes are possible within the spirit and indispensable features.

What is claimed is

1. A cleaning mat comprising a single rubber layer including many extra-fine short fibers which undirectionally protrude from a surface of the rubber layer to form brush-like protruding portions.

2. A cleaning mat comprising a single rubber layer including many extra-fine short fibers which undirectionally protrude from a surface of the rubber layer to form brush-like protruding portions, and an elongation prevention canvas embedded on a reverse face side of the rubber layer.

3. The cleaning mat as set forth in claim 1 or claim 2, wherein a crank bar for mechanically fix the rubber layer wound around an attachment roll is attached to each of both end portions of the rubber layer.

4. A cleaning mat comprising a single rubber layer including many extra-fine short fibers which undirectionally protrude from a surface of the rubber layer to form brush-like protruding portions, and an elastic layer layered on a reverse face of the rubber layer.

5. A cleaning mat comprising a single rubber layer including many extra-fine short fibers which undirectionally protrude from a surface of the rubber layer to form brush-like protruding portions, and an elongation prevention plastic sheet layered on a reverse face of the rubber layer.

6. The cleaning mat as set forth in claim 1, 2, 4, or 5, wherein an attachment reverse face, which contacts an attachment roll, is formed coarse.

7. The cleaning mat as set forth in claim 1, 2, 4, or 5, wherein hardness of the rubber layer is set to be 30 to 48 degrees in JIS-A.

8. The cleaning mat as set forth in claim 1, 2, 4, or 5, wherein thickness of the extra-fine short fiber is set to be 2 to 20 deniers and the rubber layer includes at least two kinds of extra-fine short fibers having different thicknesses.

9. The cleaning mat as set forth in claim 1, 2, 4, or 5, wherein average length of the brush-like protruding portions is set to be 0.1 to 3 mm.

10. A manufacturing method for cleaning mat comprising the steps of:
mixing and kneading many extra-fine short fibers with raw rubber material;
forming a single rubber layer with vulcanization; and
forming brush-like protruding portions by making the extra-fine short fibers protruding undirectionally from a surface of the rubber layer by means of polishing the surface of the rubber layer.

11. A manufacturing method for cleaning mat comprising the steps of:
laying an elongation prevention canvas in a mold for vulcanization;
feeding composite rubber made by mixing and kneading many extra-fine short fibers with raw rubber material;
forming a single rubber layer in which the canvas is embedded on a reverse face side by heating with press and vulcanization; and
forming brush-like protruding portions by making the extra-fine short fibers protruding undirectionally from a surface of the rubber layer by means of polishing the surface of the rubber layer.
